(19) United States
(12) Patent Application Publication
(10) Pub. No.: US 2017/0243340 A1
(43) Pub. Date: Aug. 24, 2017

(54) TECHNIQUES FOR DETERMINING ABSOLUTE COLOR VALUES FOR MULTIMEDIA CONTENT ELEMENTS

(71) Applicant: Prospera Technologies, Ltd., Tel-Aviv (IL)

(72) Inventors: Raviv ITZHAKY, Maale Adumim (IL); Daniel KOPPEL, Raanana (IL); Simeon SHPIZ, Bat Yam (IL)

(73) Assignee: Prospera Technologies, Ltd., Tel-Aviv (IL)

(21) Appl. No.: 15/438,349

(22) Filed: Feb. 21, 2017

Related U.S. Application Data
(60) Provisional application No. 62/297,873, filed on Feb. 21, 2016.

(51) Int. Cl. G06T 7/00; H04N 5/225; A01G 25/00; G06K 9/62; A01G 1/00; G06T 7/90; G06K 9/46

(52) U.S. Cl. CPC G06T 7/0004; G06T 7/90; H04N 5/2256; G06K 9/4661; G06K 9/6215; G06K 9/4652; A01G 1/001; A01G 25/00; G06T 2207/30188; G06K 2009/4666

(57) ABSTRACT

A system and method for determining at least one absolute color value for a target area. The method includes configuring a light source to emit light toward the target area, wherein the target area includes at least one crop; causing a capturing device to capture at least one artificial illumination multimedia content element showing the at least one crop in the target area while the light source emits the light; receiving, from the capturing device, the captured at least one artificial illumination multimedia content element; analyzing, via machine vision, the captured at least one artificial illumination multimedia content element; and determining, based on the analysis, at least one absolute color value of the at least one crop, wherein the at least one absolute color value is utilized to calibrate a plant monitoring system.

### CROSS-REFERENCE TO RELATED APPLICATIONS

This application claims the benefit of U.S. Provisional Patent Application No. 62/297,873 filed on Feb. 21, 2016, the contents of which are hereby incorporated by reference.

### TECHNICAL FIELD

The present disclosure relates generally to automated plant monitoring, and more specifically to calibration of color-based automated plant monitoring systems.

### BACKGROUND

Despite the rapid growth of the use of technology in many industries, agriculture continues to utilize manual agronomy techniques for evaluating and predicting crop growth. Agronomy is the science of producing and using plants for food, fuel, fiber, and land reclamation. Agronomy involves use of principles from a variety of arts including, for example, biology, chemistry, economics, ecology, earth science, and genetics. Modern agronomists are involved in issues such as improving quantity and quality of food production, managing the environmental impacts of agriculture, extracting energy from plants, and so on. Agronomists often specialize in areas such as crop rotation, irrigation and drainage, plant breeding, plant physiology, soil classification, soil fertility, weed control, and insect and pest control.

The plethora of duties assumed by agronomists require critical thinking to solve problems. For example, when planning to improve crop yields, an agronomist must study a farm's crop production to discern the best ways to plant, harvest, and cultivate the plants, regardless of climate. Additionally, agronomists must develop methods for controlling weeds and pests to keep crops disease free. To these ends, the agronomist must continually monitor progress to ensure optimal results.

Pursuant to the need to monitor progress, agronomists frequently visit the fields in which crops are grown to assess the plant production and to identify and solve any problems encountered. Solving the crop problems may include, for example, updating the instructions for chemicals and/or fertilizers used on the crops, altering a watering schedule, removing harmful wildlife from the fields, and so on.

Agronomists often use mathematical and analytical skills in conducting their work and experimentation. Complex data resulting from such use must be converted into a format that is ready for public consumption. As a result, agronomists communicate their findings via a wide range of media, including written documents, presentations, speeches, and so on. Such communication must further take diplomacy into consideration, particularly when the communication involves sensitive matters.

Reliance on manual observation of plants to identify and address problems is time-consuming, expensive, and subject to human error. Additionally, even when agronomists frequently observe the plants, problems may not be identified immediately. Such stalled identification leads to slower response times. As a result, the yield of such plants may be sub-optimal, thereby resulting in lost profits.

Although some solutions for automated plant monitoring exist, such systems are typically based on multimedia analysis using machine vision techniques. Specifically, some existing solutions analyze images of crops to identify characteristics of the crops as well as environmental characteristics (e.g., characteristics of the field in which the crops are planted). Because plant condition is often illustrated via plant colors (i.e., such that abnormal colors may indicate poor conditions that will result in lower yield), such multimedia analysis typically uses color images to determine plant characteristics.

Colors featured in multimedia content that is analyzed using existing automated plant monitoring systems may be inaccurate to reality, as conditions surrounding capturing of the multimedia content such as sunlight and moonlight (or lack thereof), fog, distance of the plant from the capturing device, size of the plant or portions thereof, and the like. Further, such solutions may face challenges in distinguishing among shades of color (e.g., pine green as opposed to shamrock green), which may be crucial to determining the health of some types of plants. As a result, such existing solutions are typically unable to utilize color in multimedia to accurately determine plant condition.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a method for determining at least one absolute color value for a target area. The method includes configuring a light source to emit light toward the target area, wherein the target area includes at least one crop; causing a capturing device to capture at least one artificial illumination multimedia content element showing the at least one crop in the target area while the light source emits the light; receiving, from the capturing device, the captured at least one artificial illumination multimedia content element; analyzing, via machine vision, the captured at least one artificial illumination multimedia content element; and determining, based on the analysis, at least one absolute color value of the at least one crop, wherein the at least one absolute color value is utilized to calibrate a plant monitoring system.

Certain embodiments disclosed herein also include a non-transitory computer readable medium having stored thereon instructions for causing a processing circuitry to execute a process, the process comprising: configuring a light source to emit light toward the target area, wherein the target area includes at least one crop; causing a capturing device to capture at least one artificial illumination multimedia content element showing the at least one crop in the target area while the light source emits the light; receiving, from the capturing device, the captured at least one artificial illumination multimedia content element; analyzing, via machine vision, the captured at least one artificial illumination multimedia content element; and determining, based on the analysis, at least one absolute color value of the at least one crop, wherein the at least one absolute color value is utilized to calibrate a plant monitoring system.

Certain embodiments disclosed herein also include a system for determining at least one absolute color value for a target area including at least one object, comprising: a processing circuitry; and a memory, the memory containing instructions that, when executed by the processing circuitry, configure the system to: configure a light source to emit light toward the target area, wherein the target area includes at least one crop; cause a capturing device to capture at least one artificial illumination multimedia content element showing the at least one crop in the target area while the light source emits the light; receive, from the capturing device, the captured at least one artificial illumination multimedia content element; analyze, via machine vision, the captured at least one artificial illumination multimedia content element; and determine, based on the analysis, at least one absolute color value of the at least one crop, wherein the at least one absolute color value is utilized to calibrate a plant monitoring system.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram utilized to describe the various disclosed embodiments.

FIG. 2 is a schematic diagram of a color analyzer according to an embodiment.

FIG. 3 is a flowchart illustrating a method for determining at least one absolute color for a target area via emission of light according to an embodiment.

FIG. 4 is a flowchart illustrating a method for determining at least one absolute color for a target area including a known color article according to another embodiment.

FIGS. 5A and 5B show simulations illustrating capturing images of a target area to determine absolute colors.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments include a method and system for determining absolute color values of multimedia content elements. At least one multimedia content element featuring at least a portion of a target area including at least one crop is captured. The at least one multimedia content element is analyzed to determine at least one absolute color value of the at least one crop. The determined at least one absolute color value may be utilized to, for example, calibrate plant monitoring systems configured to monitor plant condition with respect to color.

In an embodiment, the analysis may include causing emission of light toward the target area and analyzing an artificial illumination multimedia content element showing the target area during emission of light via the light source. In another embodiment, the analysis may include comparing a color value of a known color article shown in the at least one multimedia content element to a predetermined absolute color value of the known color article and determining, based on the comparison and the at least one multimedia content element, at least one absolute color value of the at least one crop shown in the at least one multimedia content element.

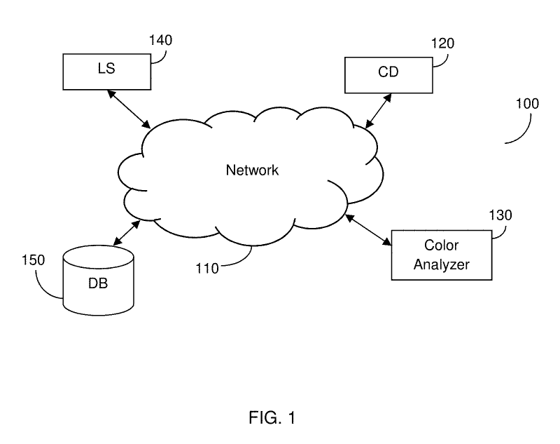

FIG. 1 shows an example network diagram 100 utilized to describe the various disclosed embodiments. The network diagram 100 includes a capturing device 120, a color analyzer 130, a light source 140, and a database 150 communicatively connected via a network 110. The network 110 may be, but is not limited to, a wireless, cellular or wired network, a local area network (LAN), a wide area network (WAN), a metro area network (MAN), the Internet, the worldwide web (WWW), similar networks, and any combination thereof.

The capturing device 120 is located in proximity (e.g., physical proximity, such as within a predetermined distance) to a target area including at least one crop. As a non-limiting example, the target area may be a field including plants to be monitored. The capturing device 120 may be stationary or mobile, and is configured to capture multimedia content elements showing the crops in the target area. Each multimedia content element may be an image, a video, or any other visual depiction of the target area. The capturing device 120 may be, but is not limited to, a still camera, a red-green-blue (RGB) camera, a red-green-blue-near infrared (RGBN) camera, a shortwave infrared (SWIR) camera, a thermal imaging radar (TIR) camera, a multi spectral camera, a hyper spectral camera, a video camera, and the like. The capturing device 120 may be operated using electricity, solar energy, other forms of energy, or a combination thereof. In some implementations, the capturing device 120 may be assembled on a mobile unit such as, but not limited to, a drone, a patrolling vehicle, a satellite, and the like.

The light source 140 is also located in proximity to the target area and may be configured to emit light at least toward the target area. The light source 140 may be, but are not limited to, a light-emitting diode (LED), a visible light source, an infrared (IR) light source, and the like.

In an embodiment, the color analyzer 130 is configured to determine at least one absolute color value for the crops in the target area. Each crop may be, but is not limited to, a plant, a fungus, a bacterial colony, or any other organism to be grown and harvested. When multimedia content elements (e.g., images and videos) of a target area are captured, effects such as lighting, angle, and the like may affect the appearance of a crop, thereby causing the actual colors captured in the multimedia content elements to be different from the true colors of the crops shown therein. Each absolute color value is a color value indicating a distinct shade (i.e., a lightness) of color that represents the true color of the crop (or a portion thereof) as opposed to the actual color shown in a multimedia content element of the target area. The at least one absolute color value can be utilized to, e.g., calibrate machine vision-based monitoring systems, thereby achieving more accurate processing. Each absolute color value is distinct in that different absolute color values represent different shades of a given color.

Each absolute color value is related to a crop or a portion thereof shown in the at least one multimedia content element. For plants, absolute color values for the plants may indicate colors of leaves, stems, fruits, flowers, roots, buds, and other portions of the plants. As a non-limiting example, for a monitored apple tree, the absolute color values may include absolute color values indicating shades of apples, leaves, and bark of the tree, respectively. Further, the absolute color values may indicate different shades for particular plant portions (e.g., color values of different colored leaves), as such different colored portions may be indicative of, e.g., early stages of plant diseases.

In an embodiment, the color analyzer 130 is configured to receive at least one multimedia content element showing a target area from the capturing device 120. The target area includes at least one crop (e.g., a plant), at least one portion thereof (e.g., leaves and a stem of one or more plants), or both. In a further embodiment, the color analyzer 130 is configured to analyze the at least one multimedia content element showing the target area. The analysis may include, but is not limited to, machine vision analysis of the at least one multimedia content element. The analysis results in identification of at least one actual color value of crops shown in the at least one multimedia content element. Based on the analysis, the color analyzer 130 is configured to determine at least one absolute color of the at least one crop. Determining the at least one absolute color may include analyzing at least one artificial illumination multimedia content element showing the target area with light emitted from the light source 140, comparing at least one actual color value of a known color article shown in the at least one multimedia content element to a predetermined absolute color value of the known color article, or both.

In an embodiment, determining the at least one absolute color includes analyzing at least one artificial illumination multimedia content element. In a further embodiment, the color analyzer 130 is configured to cause the light source 140 to emit light toward the target area and to cause the capturing device 120 to simultaneously capture the at least one artificial illumination multimedia content element. The emission of light is performed to increase the accuracy of the actual colors of the at least one multimedia content element to the absolute colors of the crops shown therein. Thus, the at least one artificial illumination multimedia content element may be analyzed to determine the at least one absolute color. The intensity of light emitted from the light source 140 may be a predetermined intensity.

In an embodiment, the color analyzer 130 may be configured to configure the light source 140 to emit the light at a predetermined intensity. In a further embodiment, the color analyzer 130 may be configured to select the predetermined intensity of light to be emitted based on a natural amount of light of a natural illumination multimedia content element showing the target area without light emitted by the light source 140, a current time of each of the at least one multimedia content element, a weather of the target area, at least one characteristic of the target area, at least one characteristic one or more crops in the target area, or a combination thereof.

In an embodiment, the color analyzer 130 may be configured to receive, from the capturing device 120, the at least one natural illumination multimedia content element captured by the capturing device 120 while the light source 140 is not emitting any light. In a further embodiment, the color analyzer 130 is configured to cause the capturing device 120 to capture the at least one natural illumination multimedia content element. In yet a further embodiment, the color analyzer 130 is configured to analyze, via machine vision, the at least one natural illumination multimedia content element and to select, based on the analysis, the intensity of light to be emitted toward the target area.

In a further embodiment, based on the at least one natural illumination multimedia content element, the color analyzer 130 is configured to determine a natural amount of light reflected within the target area without emission of light by the light source 140. The natural amount of light reflected in the target area affects the color of the crops of the target area as shown in the at least one natural illumination multimedia content element. The natural amount of light may be a total amount of visible light (e.g., as expressed in lumens). In yet a further embodiment, based on the determined natural amount of light, the color analyzer 130 is configured to determine an intensity of light to be emitted by the light source 140. In a further embodiment, the intensity of light may be a predetermined intensity, and the color analyzer 130 may be configured to select the predetermined intensity based on the natural amount of light reflected within the target area.

In an embodiment, the color analyzer 130 is configured to analyze the at least one natural illumination multimedia content element using machine vision, wherein the natural amount of light reflected within the target area may be determined based on the machine vision analysis.

In another embodiment, the color analyzer 130 is configured to identify a current time of the at least one natural illumination multimedia content element captured for the target area and to determine, based on the identified current time, the natural amount of light reflected in the target area. The current time may be a specific time (e.g., 3:01 PM), or may be a range of times (e.g., between 4-5 PM, midnight, midday, twilight, sunrise, sunset, etc.). The current time may be further identified with respect to a time zone of the target area (for example, for a target area in the Eastern Time Zone, the current time may be 12:30 AM ET or midnight ET). As a non-limiting example for determining the natural amount of light reflected within the target area, if the current time is midnight, complete darkness (i.e., a natural amount of light of 0 candelas) may be determined.

In yet another embodiment, the natural amount of light reflected in the target area may be further determined based on weather in the target area at the time of capture of the at least one initial multimedia content element. Such weather may be, but is not limited to, sunny, cloudy, partly cloudy, moonlit, degrees thereof, and the like. Data related to the weather in the target area at the time of capture may be retrieved from one or more data sources (not shown) storing weather data over time.

In another embodiment, the color analyzer 130 may be configured to select the intensity of light to be emitted based on at least one target characteristic of the target area, the crops in the target area, or both. Such target characteristics may include, but are not limited to, a type of crop (e.g., which types of organisms are grown), a type of soil the crops are planted in, a geographical location of the target area, irrigation and drainage indicators, plant breeding data, plant physiology data, weed control data, insect and pest control data, combinations thereof, and the like. In a further embodiment, the color analyzer 130 is further configured to determine the at least one target characteristic by analyzing, via machine vision, the at least one natural illumination multimedia content element. As a non-limiting example, if a type of the crop is tomato plant, the selected intensity of light may be 100 lumens. As another non-limiting example, the selected intensity of light may be 200 lumens if the natural amount of light is 0 lumens, and the selected intensity of light may be 50 lumens if the natural amount of light is 100 lumens.

In an embodiment, the color analyzer 130 may be configured to determine the characteristics by analyzing, via machine vision, at least one multimedia content element showing the target area (e.g., by analyzing the at least one natural illumination multimedia content element). In a further embodiment, the color analyzer 130 may be configured to send, to the light source 140, an instruction to emit the selected amount of light, thereby causing the light source 140 to emit light toward the target area.

In another embodiment, the color analyzer 130 may be configured to select a hue of light to be emitted toward the target area by the light source 140. The selected hue may be, e.g., red, orange, yellow, green, blue, or violet. The selected hue may be based on the target characteristics. Using different hues of light may be useful for, e.g., controlling heat generated due to absorption of light.

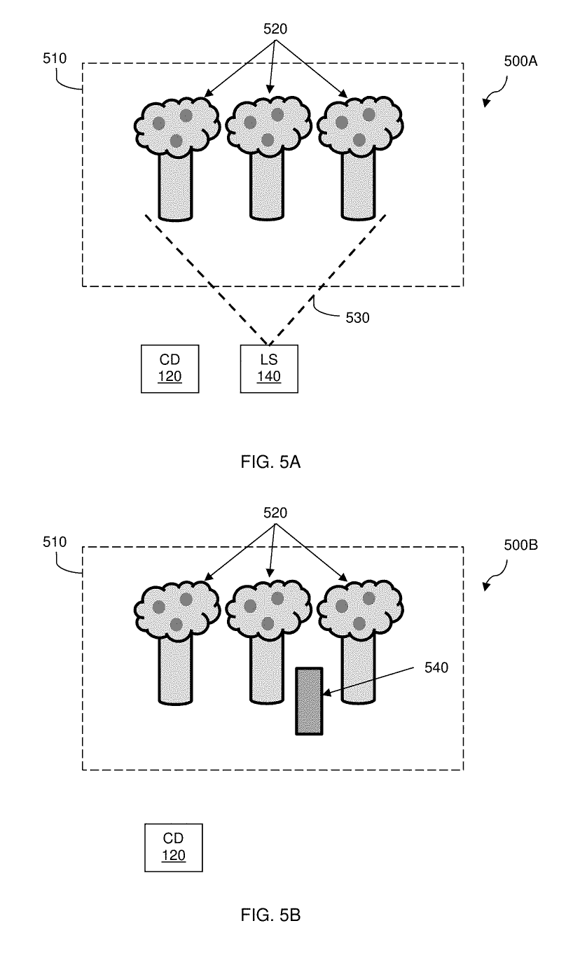

FIG. 5A is an example simulation 500A utilized to describe determining absolute color values using an artificial illumination multimedia content element. A target area 510 includes a plurality of crops 520. In the example simulation shown in FIG. 5, the target area 510 is a field and the crops 520 are fruit-bearing trees. The light source 140 is deployed in physical proximity to the target area 510 and emits light 530 toward the target area 510. The capturing device 120 may further be configured to capture at least one natural illumination image when the light source 140 is not emitting the light 530. The at least one natural illumination image may be analyzed (e.g., by the color analyzer 130, not shown), and an intensity of the light 530 to be emitted by the light source 140 may be selected based on the analysis. The capturing device 120 is also deployed in physical proximity to the target area 510 and is configured to capture, while the light source 140 simultaneously emits the light 530 toward the target area 510, an image showing at least a portion of the target area 510 and, more specifically, a portion of the target area including at least a portion of the crops 520. The image may be utilized as the at least one artificial illumination multimedia content element.

In another embodiment, determining the at least one absolute color includes comparing an actual color shown in the at least one multimedia content element to at least one predetermined color. To this end, the target area may further include a known color article. The known color article is any object that has at least one known absolute color value, and may be utilized as a control for the absolute color determination. The known color article may be, but is not limited to, a pole, a clip, a board, a sign, and the like. As a non-limiting example, the known color article may be a pole having a known shade of purple placed in a field near one or more lemon trees. The known color article may be affixed to the capturing device 120. The known color article may be fixed or modular. In an example implementation, the known color article is deployed at a predetermined distance and angle with respect to the capturing device 120, the light source 140, or both.

FIG. 5B is an example simulation 500B utilized to describe determining absolute color values using a known color article. A target area 510 includes a plurality of crops 520. In the example simulation shown in FIG. 5B, the target area 510 is a field, the crops 520 are fruit-bearing trees, and the known color article 540 is a red board having a predetermined absolute color value. The capturing device 120 is deployed in physical proximity to the target area 510 and is configured to capture an image showing at least a portion of the target area 510 and, more specifically, a portion of the target area including at least a portion of the crops 520 and the known color article 540. The captured image may be analyzed (e.g., by the color analyzer 130, not shown) via machine vision to determine a color value of the known color article 540 as shown in the image, which can be compared to a predetermined absolute color value of the known color article 540 to determine a color value difference. Based on the color value difference and color values of parts of the crops 520 (e.g., color values of the tree bark, leaves, and fruit) as shown in the image, absolute color values of the parts of the crops 520 can be determined.

In an embodiment, the color analyzer 130 may be configured to send, to the database 150, the at least one absolute color value determined for the target area. The absolute color values may be stored in association with the target area or portions thereof (e.g., particular crops or groups of crops in the target area). In a further embodiment, the color analyzer 130 may be configured to calibrate one or more monitoring systems (not shown) that determines conditions of plants or other organisms at least partially based on color. To this end, the database 150 may be accessible to the one or more monitoring systems to be calibrated. The at least one absolute color may be utilized as an index for determining color values associated with crops in multimedia content elements. The absolute color values may provide more accurate color values, which may be utilized for ensuring accurate analysis of, e.g., chlorophyll in plants, which typically requires highly accurate color differentiation to effectively evaluate plant conditions.

In another embodiment, based on the determined at least one absolute color, the color analyzer 130 may be configured to determine at least one condition of plants shown in the at least one multimedia content element. The at least one condition may include, but is not limited to, a chlorophyll level, a brix level, diseases, and the like. In a further embodiment, the color analyzer 130 may be configured to compare the at least one absolute color value to a plurality of absolute color values of plants having various conditions, where the at least one condition is determined based on the comparison. For example, for a rose bush, determined absolute color values of roses of the rose bush may be compared to absolute color values of roses in various healthy (i.e., not diseased) and unhealthy (e.g., diseased) conditions.

It should be noted that the embodiments described herein with respect to FIG. 1 are discussed with respect to a single capturing device 120 and a single light source 140 merely for simplicity purposes and without limitation on the disclosed embodiments. Multiple capturing devices, multiple light sources, or both, may be equally utilized. Multiple capturing devices may be utilized to, for example, provide backups in case of failure, to provide additional multimedia to be analyzed (thereby providing additional data for, e.g., validating absolute color value determinations), and the like.

It should also be noted that the capturing device 120, the color analyzer 130, and the light sources 140, are described herein above with respect to FIG. 1 as separate components merely for simplicity purposes and without limitation on the disclosed embodiments. Any of the capturing device 120, the color analyzer 130, and the light sources 140 may be included in a combined system configured to perform the embodiments disclosed herein. As a non-limiting example, the capturing device 120 and the light sources 140 may be included as components of the color analyzer 130. As another non-limiting example, the capturing device 120 and the light sources 140 may be incorporated into a single device (not shown) such as, for example, a camera having a flash unit.

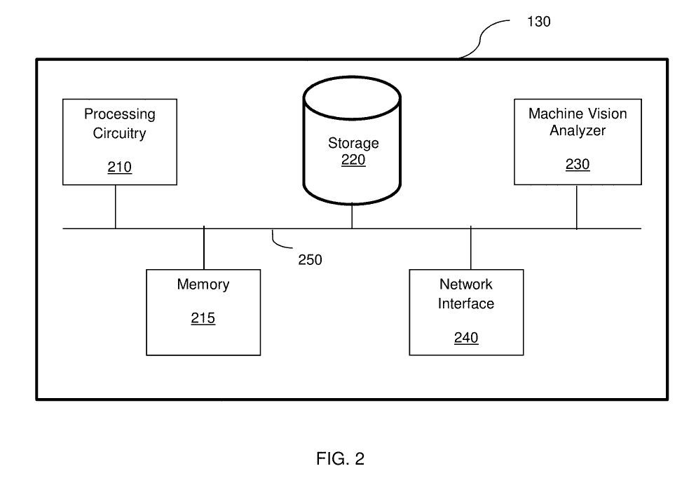

FIG. 2 is an example schematic diagram of the color analyzer 130 according to an embodiment. The color analyzer 130 includes a processing circuitry 210 coupled to a memory 215, a storage 220, a machine vision analyzer 230, and a network interface 240. In an embodiment, the components of the color analyzer 130 may be communicatively connected via a bus 250.

The processing circuitry 210 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), general-purpose microprocessors, microcontrollers, digital signal processors (DSPs), and the like, or any other hardware logic components that can perform calculations or other manipulations of information.

The memory 215 may be volatile (e.g., RAM, etc.), non-volatile (e.g., ROM, flash memory, etc.), or a combination thereof. In one configuration, computer readable instructions to implement one or more embodiments disclosed herein may be stored in the storage 220.

In another embodiment, the memory 215 is configured to store software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing circuitry 210 to perform the various processes described herein. Specifically, the instructions, when executed, cause the processing circuitry 210 to perform determination of absolute color values for target areas used for calibration of crop monitoring systems, as discussed herein.

The storage 220 may be magnetic storage, optical storage, and the like, and may be realized, for example, as flash memory or other memory technology, CD-ROM, Digital Versatile Disks (DVDs), or any other medium which can be used to store the desired information.

The machine vision analyzer 230 is configured to analyze multimedia content elements via machine vision. Further, the machine vision analyzer 230 is configured to determine actual color values of crops shown in multimedia content elements. The color values are distinct shades of colors of the crops.

The network interface 240 allows the color analyzer 130 to communicate with the capturing device 120, the light source 140, the database 150, or a combination thereof, for the purpose of, for example, causing capturing of multimedia content elements, causing emission of light toward target areas, storing determined absolute color values, and the like.

It should be understood that the embodiments described herein are not limited to the specific architecture illustrated in FIG. 2, and other architectures may be equally used without departing from the scope of the disclosed embodiments.

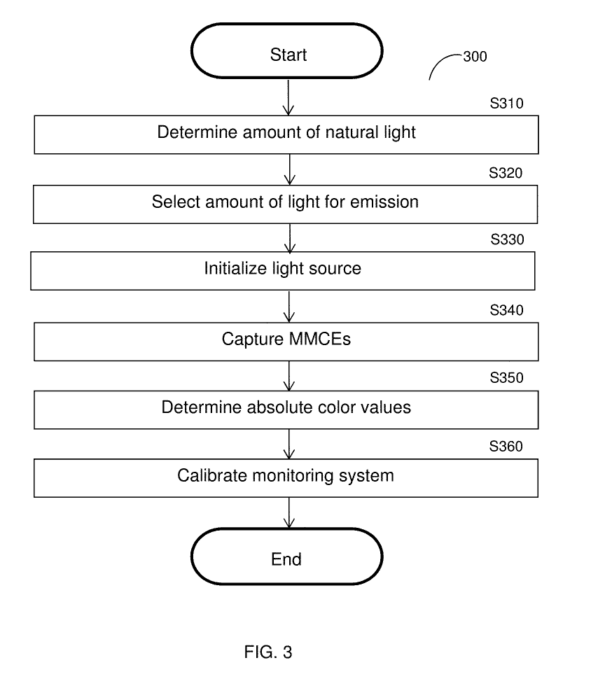

FIG. 3 is an example flowchart 300 illustrating a method for determining at least one absolute color value for a target area via emission of light according to an embodiment. The target area includes at least one crop such as, but not limited to, plants, fungi, and the like. In an embodiment, the method may be performed by the color analyzer 130.

At optional S310, a natural amount of light reflected in the target area at a certain time is determined. In an embodiment, S310 includes receiving at least one natural illumination multimedia content element at the certain time. The at least one natural illumination multimedia content element shows at least a portion of the target area without artificial illumination via a light source, and may be, an image, a video, or any other visual representation of the target area. The at least a portion of the target area includes at least a portion of the at least one crop. In a further embodiment, S310 includes analyzing, via machine vision techniques, the at least one natural illumination multimedia content element to determine the natural amount of light.

In another embodiment, the natural amount of light may be estimated based on a current time at the target area, a current weather at the target area, historical light data for the target area (i.e., values of natural amounts of light at the target area at previous times, during previous weather conditions, or both), a combination thereof, and the like. The estimation may be further based on previous light data of the target area with respect to times, weather, or both. As a non-limiting example, if previous light data for the target area indicates that an amount of light reflected in the target area at 6 AM when the during sunny weather is on average 200 lumens, the determined amount of light at a time of 6 AM when the weather is sunny may be estimated as 200 lumens.

At S320, an intensity of light to be emitted toward the target area is selected. In an embodiment, the selected intensity may be based on the determined natural amount of light, at least one characteristic of the target area, at least one characteristic of one or more crops in the target area, or a combination thereof. In an embodiment, different characteristics may be associated with different predetermined light intensities. In another embodiment, each predetermined intensity may be associated with a natural amount of light or range of natural amounts of light such that a predetermined intensity associated with the determined natural amount of light is selected. As a non-limiting example, if the natural amount of light reflected in the target area is between 50-100 lumens, the selected intensity of light may be 150 lumens. Thus, in a further embodiment, S320 may include comparing the determined natural amount of light or each characteristic to values in a table associated with predetermined intensities of light to be emitted.

In yet another embodiment, S320 may include selecting a hue of light to be emitted. In a further embodiment, the hue may be determined based on the analysis of the at least one natural illumination multimedia content element. In yet a further embodiment, the hue may be determined based on at least one hue of color shown in the at least one natural illumination multimedia content element. As a non-limiting example, if the target area captured in the at least one natural illumination multimedia content element includes white corn, a different (i.e., not white) hue of light may be selected.

At S330, a light source is initiated, thereby causing the light source to emit light toward the target area. The intensity of emitted light may be the selected intensity, or a predetermined default intensity of light. In an embodiment, S330 includes configuring the light source to emit the selected intensity of light toward the target area.

At S340, a capturing device is initiated, thereby causing the capturing device to capture at least one artificial illumination multimedia content element showing at least a portion of the target area. In an embodiment, S340 further includes receiving the captured at least one multimedia content element.

At S350, the captured at least one artificial illumination multimedia content element is analyzed to determine at least one absolute color value shown in the at least one multimedia content element. The analysis may include, but is not limited to, machine vision analysis to identify at least one color of the at least one crop shown in the at least one multimedia content element, where the at least one absolute color value is determined based on the identified at least one color.

At S360, the determined at least one color value is utilized to calibrate at least one monitoring system. In an embodiment, S360 may include storing the at least one color value in a database accessible to the at least one monitoring system, where the at least one color value is utilized as an index for determining color measurements.

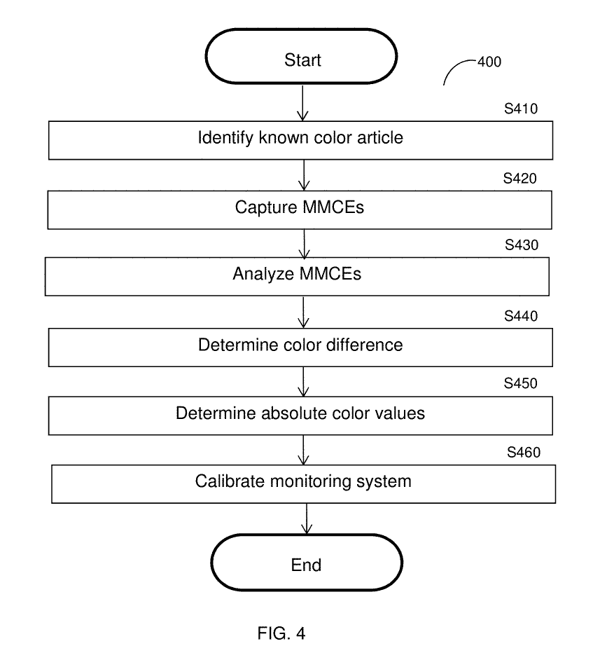

FIG. 4 is an example flowchart 400 illustrating determining at least one absolute color for a target area including a known color article according to another embodiment. The target area also includes at least one crop such as, but not limited to, plants, fungi, and the like. The target area further includes a known color article. The known color article is associated with a predetermined absolute color value representing the true shade of a color of the article, and may be any object such as, but not limited to, a board, a clip, a pole, a sign, and the like. In an embodiment, the method may be performed by the color analyzer 130.

At S410, the known color article the target area is identified. In an embodiment, S410 may include, but is not limited to, machine imaging analysis of multimedia content showing the target area to determine whether the known color article is shown therein, detecting a signal from the proximate known color article, or via any other technique for identifying the particular known color article in the target area. In a further embodiment, the known color article may be identified only if it is within a threshold distance, a required range of angles, or both, with respect to a capturing device that is proximate to the target area. The threshold distance and required range of angles may be predetermined, and may be utilized to ensure that a portion of the article having the known absolute color value is shown in any multimedia content elements captured by the capturing device. In yet a further embodiment, if the known color article is not within the threshold distance or required range of angles, the known color article, the capturing device, or both, may be moved until the known color article is identified within the threshold distance, the required range of angles, or both.

At S420, the capturing device is initiated, thereby causing the capturing device to capture at least one multimedia content element showing at least a portion of the target area including the known color article. In an embodiment, S420 further includes receiving the captured at least one multimedia content element.

At S430, the captured at least one multimedia content element is analyzed. The analysis may include, but is not limited to, machine vision analysis to identify at least one color shown in the at least one multimedia content element, wherein the identified at least one color includes a color of the known color article as shown in the at least one multimedia content element. In an embodiment, S430 may further include determining a color value for each identified color.

At S440, the identified color value of the known color article as shown in the multimedia content element and the predetermined absolute color value associated with the known color article are compared to determine a difference in color value. The difference in color value may be a numerical value representing the difference in shade of the true color of the known color article and the actual color shown in the at least one multimedia content element. The difference may further be positive or negative, where the positivity or negativity of the difference may indicate that the absolute color value is lighter or darker than the actual color value, respectively (or vice versa).

At S450, based on the determined color difference and the identified at least one color shown in the multimedia content element, at least one absolute color value of the at least one multimedia content element is determined.

At S460, the determined at least one color value is utilized to calibrate at least one monitoring system. In an embodiment, S460 may include storing the at least one color value in a database accessible to the at least one monitoring system, where the at least one color value is utilized as an index for determining color measurements.

It should be noted that the method for absolute color determination using an artificial illumination multimedia content element described with respect to FIG. 3 and the method for absolute color determination using a known color article described with respect to FIG. 4 may be combined without departing from the scope of the disclosure. Such a combined absolute color determination may be utilized to, e.g., validate absolute color determinations, provide more accurate determinations, or both. For example, a predetermined amount of light may be emitted toward a target area including a known color article, and any differences between the color value of the illuminated known color article as shown in an image of the target area and the absolute color value of the known color article may be utilized to determine other absolute color values of crops in the target area.

It should also be noted that the disclosed embodiments are described with respect to crops or plant monitoring merely for simplicity purposes and without limitation on the disclosed embodiments. Absolute colors of any plants or other organisms having color that might be monitored to, for example, track conditions of the organisms may be equally determined without departing from the scope of the disclosure. As non-limiting examples, the disclosed embodiments may be utilized for monitoring of crops in a field or greenhouse, wild plant life in a forest or other area, wild or farmed fungi, bacterial colonies, eggs or live animals, and the like.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; A and B in combination; B and C in combination; A and C in combination; or A, B, and C in combination.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for determining at least one absolute color value for a target area, comprising:
configuring a light source to emit light toward the target area, wherein the target area includes at least one crop;
causing a capturing device to capture at least one artificial illumination multimedia content element showing the at least one crop in the target area while the light source emits the light;
receiving, from the capturing device, the captured at least one artificial illumination multimedia content element;
analyzing, via machine vision, the captured at least one artificial illumination multimedia content element; and
determining, based on the analysis, at least one absolute color value of the at least one crop, wherein the at least one absolute color value is utilized to calibrate a plant monitoring system.

2. The method of claim 1, further comprising:
selecting, from among a plurality of predetermined light intensities, an intensity of the light to be emitted, wherein the light source is configured based on the selected intensity.

3. The method of claim 2, wherein the selection is based on at least one characteristic, wherein each characteristic relates to the target area or the at least one crop.

4. The method of claim 3, wherein the at least one characteristic includes at least one of: a type of crop in the target area, a type of soil in the target area, a geographical location of the target area, irrigation and drainage indicators, plant breeding data, plant physiology data, weed control data, and pest control data.

5. The method of claim 2, wherein selecting the intensity further comprises:
determining a natural amount of light in the target area, wherein the intensity of the light to be emitted is selected based on the determined natural amount of light.

6. The method of claim 5, wherein determining the natural amount of light further comprises:
analyzing, via machine vision, at least one natural illumination multimedia content element showing the target area while the light source is not emitting light.

7. The method of claim 6, further comprising:
determining, based on the analysis of the at least one natural illumination multimedia content element, a hue of light to be emitted, wherein the light source is further configured based on the determined hue.

8. The method of claim 5, wherein the natural amount of light is determined based on at least one of: current time at the target area, a current weather at the target area, and historical light data of the target area.

9. The method of claim 1, wherein the target area includes a known color article, wherein the known color article is associated with a predetermined absolute color value, further comprising:
determining an actual color value of the known color article as shown in the captured at least one artificial illumination multimedia content element;
determining a color value difference between the determined actual color value and the predetermined absolute color value, wherein the at least one absolute color value for the target area is determined further based on the color value difference.

10. A non-transitory computer readable medium having stored thereon instructions for causing a processing circuitry to execute a process, the process comprising:
configuring a light source to emit light toward a target area, wherein the target area includes at least one crop;
causing a capturing device to capture at least one artificial illumination multimedia content element showing the at least one crop in the target area while the light source emits the light;
receiving, from the capturing device, the captured at least one artificial illumination multimedia content element;
analyzing, via machine vision, the captured at least one artificial illumination multimedia content element; and
determining, based on the analysis, at least one absolute color value of the at least one crop, wherein the at least one absolute color value is utilized to calibrate a plant monitoring system.

11. A system for determining at least one absolute color value for a target area, comprising:
a processing circuitry; and
a memory, the memory containing instructions that, when executed by the processing circuitry, configure the system to:
configure a light source to emit light toward the target area, wherein the target area includes at least one crop;
cause a capturing device to capture at least one artificial illumination multimedia content element showing the at least one crop in the target area while the light source emits the light;
receive, from the capturing device, the captured at least one artificial illumination multimedia content element;
analyze, via machine vision, the captured at least one artificial illumination multimedia content element; and
determine, based on the analysis, at least one absolute color value of the at least one crop, wherein the at least one absolute color value is utilized to calibrate a plant monitoring system.

12. The system of claim 11, wherein the system is further configured to:
select, from among a plurality of predetermined light intensities, an intensity of the light to be emitted, wherein the light source is configured based on the selected intensity.

13. The system of claim 12, wherein the selection is based on at least one characteristic, wherein each characteristic relates to the target area or the at least one crop.

14. The system of claim 13, wherein the at least one characteristic includes at least one of: a type of crop in the target area, a type of soil in the target area, a geographical location of the target area, irrigation and drainage indicators, plant breeding data, plant physiology data, weed control data, and pest control data.

15. The system of claim 12, wherein the system is further configured to:
determine a natural amount of light in the target area, wherein the intensity of the light to be emitted is selected based on the determined natural amount of light.

16. The system of claim 15, wherein the system is further configured to:
analyze, via machine vision, at least one natural illumination multimedia content element showing the target area while the light source is not emitting light.

17. The system of claim 16, wherein the system is further configured to:
determine, based on the analysis of the at least one natural illumination multimedia content element, a hue of light to be emitted, wherein the light source is configured based on the determined hue.

18. The system of claim 15, wherein the natural amount of light is determined based on at least one of: current time at the target area, a current weather at the target area, and historical light data of the target area.

19. The system of claim 11, wherein the target area includes a known color article, wherein the known color article is associated with a predetermined absolute color value, wherein the system is further configured to:
determine an actual color value of the known color article as shown in the captured at least one artificial illumination multimedia content element; and
determine a color value difference between the determined actual color value and the predetermined absolute color value, wherein the at least one absolute color value for the target area is determined further based on the color value difference.
